(19) United States
(12) Patent Application Publication
(10) Pub. No.: US 2020/0207299 A1
(43) Pub. Date: Jul. 2, 2020

(54) SAFETY ASSISTANCE SYSTEM FOR DRIVERLESS CAR

(71) Applicants: FU DING PRECISION COMPONENT (SHEN ZHEN) CO., LTD., Shenzhen (CN); FOXCONN INTERCONNECT TECHNOLOGY LIMITED, Grand Cayman, KY (US)

(72) Inventor: CHIA-CHIEH CHENG, New Taipei (TW)

(21) Appl. No.: 16/726,164

(22) Filed: Dec. 23, 2019

(30) Foreign Application Priority Data
Dec. 21, 2018 (CN) 201811570122.9

(51) Int. Cl. B60R 21/015; B60R 21/013; B60R 21/207

(52) U.S. Cl. CPC B60R 21/01554; B60R 21/013; B60R 2021/01211; B60R 21/207; B60R 21/01516

(57) ABSTRACT

A safety assistance system for the driverless car includes a microcontroller, a sensor for detecting the door position, a sensor for detecting the seat position, a sensor for detecting a collision, an air bag controller, and an air bag. The respective sensors are electrically connected to the microcontroller via corresponding circuits, and the air bag is connected to the microcontroller via the air bag controller, the sensor for detecting the seat position includes a plurality of angularity units respective to detect the seat back direction and the seat back angle position.

### BACKGROUND OF THE DISCLOSURE

### 1. Field of the Disclosure

The present disclosure relates to a safety assistance system, and particularly to the safety assistant system for the driverless car.

### 2. Description of Related Arts

Taiwan Patent No. TW202294651 discloses an air bag deployment device for sensing the tilting situation of the car to instantly trigger the air bag deployment device when the car is accidentally falls down from the bridge or the mountain without confronting any rigid external items, e.g., the guardrails, to trigger the sensor of the deployment device.

Anyhow, such a system only provides an order to instantly activate the deployment device for all the air bags in the car in the aforementioned dangerous situation. An improvement for the deployment device is desired to precisely and efficiently recognize the respective and selective air bags in the car ready for deployment before the car is running for preparing any possible accident beforehand. In other words, only the selected air bags are activated to be deployed when the accident occurs, according to the passenger positions or information in the car acquired before the car is moving.

### SUMMARY OF THE DISCLOSURE

An object of the invention is to provide a safety assistance system for the driverless car with a microcontroller, a sensor for detecting the door position, a sensor for detecting the seat position, a sensor for detecting a collision, an air bag controller, and an air bag. The respective sensors are electrically connected to the microcontroller via corresponding circuits, and the air bag is connected to the microcontroller via the air bag controller, the sensor for detecting the seat position includes a plurality of angularity units respective to detect the seat back direction and the seat back angle position. The following steps are implemented. Step 1: starting the car to activate the microcontroller and detecting whether the doors are all closed; Step 2: activating the sensor for detecting the seat position/information including the seat direction and the adjusted seat back angle and sending corresponding data to the microcontroller; Step 3: adjusting/setting air bag controller according to the collected seat position/information efficiently; and Step 4: activating the selective air bags for deployment upon receiving a collision signal from the corresponding sensor according to the setting of the air bag controller.

Other objects, advantages and novel features of the disclosure will become more apparent from the following detailed description when taken in conjunction with the accompanying drawings.

### BRIEF DESCRIPTION OF THE DRAWINGS

FIG. 1 is a diagram showing the safety assistance system according to the invention; and

FIG. 2 is a flow chart showing how the safety assistance system of FIG. 1 works.

### DETAILED DESCRIPTION OF THE PREFERRED EMBODIMENT

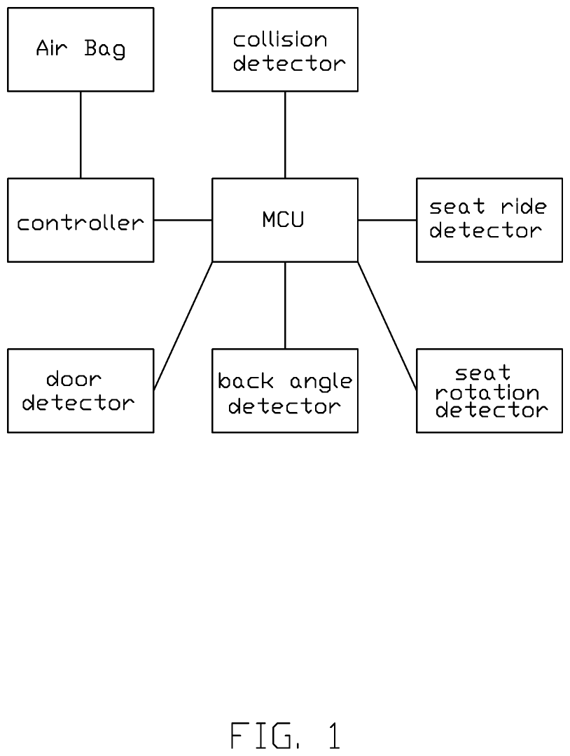

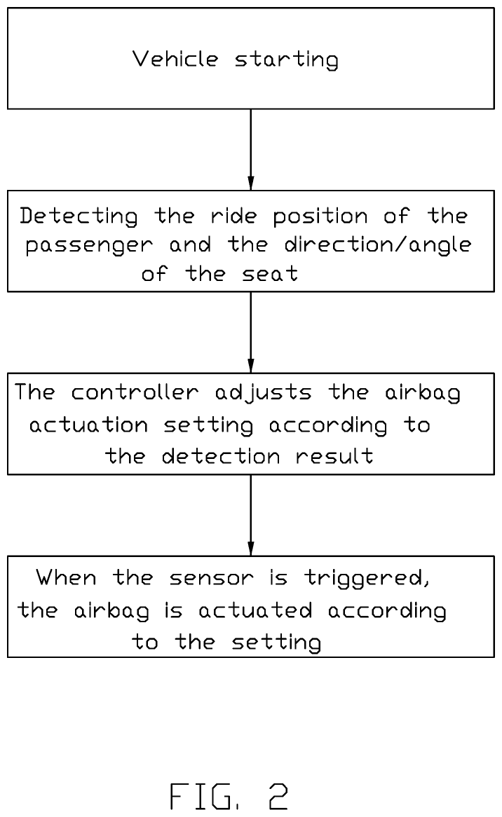

Referring to FIGS. 1 and 2, a safety assistance system for use with the driverless car provides flexibility of the passenger facing direction, e.g., the front seat passengers may face backward to face toward the rear seat passengers. The invention is to identify and recognize how the front seat passenger is seated to decide whether the air bag equipped under the front panel deck should be activated during a car accident. The system is to try to detect the front seat back position to decide how the front seat back is angled to decide which direction the front seat faces toward and what an angle of the front seat back is.

Notably, the driverless car includes the front seats, the back seats and the armrest wherein the front cars may be rotated to face backward, and the seat front edge and the armrest are supplementally provided with the air bags for as to protect the corresponding passenger in the opposite seat. The system includes a microcontroller unit (MCU), the door detector, the seat ride detector, the seat detector, the collision detector, the air bag controller and the air bags. The detectors are electrically connected to the microcontroller, the air bags are electrically connected to the microcontroller via the air bag controller, the input end of the air bag controller is connected to the microcontroller, and the seat detector includes back angle detectors and seat rotation/turning detectors so as to decide the seat direction and the seat back angle.

Each seat is equipped with the seat detectors including the seat rid detector, the seat rotation detector and the seat back tilting angle detector. In the embodiment, the sensor detects whether there is a passenger seated thereon via a pressure detector. Understandably, the same system may also decide not to activate the air bag corresponding to the seats where no passengers are available. The seat back titling angle detector, which may be equipped around the rotation shaft of the seat back, provides tilting angle information. The seat rotation detector provides the information of seat facing. Therefore, the availability of the seats, the seat facing section, and the front seat back angle information commonly result in the combo information.

The microcontroller may adjust the setting according to such a combo information to decide which air bags are required to be activated during an accident. Understandably, the air bags intentionally designed for the specific seat may not be activate if such a seat has no passenger thereon. In addition, when the front seat is used to face backward, the air bag under the deck of the front control panel is not expected to be activated because it faces the forwardly tilted front seat back. Alternately, an additional air bag may be provided in a front region of the back seat so as to be deployed toward the front seat passenger who faces backwardly. In other words, the microcontroller receives and analyzes the signals derived from the sensors so as to adjust the setting of e corresponding air bag controller.

The air bags are electrically connected and activated by the air bag controller and controlled by the air bag control including the deployed air amount, the deployment range, the deployment angle and the deployment sequence. Upon collision, the air bags are activated via the setting of the air bag controller.

The method corresponding to the aforementioned safety assistance system includes the following steps: detecting whether the car doors are closed via a door detector; activating seat detectors to obtain data regarding the seat availability, the seat direction and the seat back tilting angle; adjusting a setting of the air bag controller according to the collected data; and activating the air bags according to the setting of the air bag controller upon receiving a collision signal from a collision sensor. Understandably, the data includes activation of the corresponding air bags, the deployment air amount, the deployment range, the deployment angle and the deployment sequence.

While a preferred embodiment in accordance with the present disclosure has been shown and described, equivalent modifications and changes known to persons skilled in the art according to the spirit of the present disclosure are considered within the scope of the present disclosure as described in the appended claims.

What is claimed is:

1. A safety assistant system for use with a driverless car comprising:
a microcontroller;
a set of seat detectors connected to the microcontroller to collect data regarding at least seat availability and seat facing for corresponding seats; and
an air bag controller to adjust a setting to activate corresponding air bags according to the collected data upon collision.

2. The safety assistance system as claimed in claim 1, wherein the set of seat detectors further collects data regarding a tilting angle of a seat back of the corresponding seat so as to decide a deployment air amount of the air bag for not hurting a corresponding passenger on said seat.

3. The safety assistance system as claimed in claim 1, wherein said set of seat detectors includes a seat ride detector which is a pressure sensor.

4. The safety assistance system as claimed in claim 1, wherein said set of seat detectors includes a seat rotation detector to decide whether at least one of front seats of the car is turned to face backward.

5. The safety assistance system as claimed in claim 1, further including a door detector electrically connected to the microcontroller to detect whether doors are closed.

6. The safety assistance system as claimed in claim 5, wherein the set of seat detectors is activated to collect the data only after detection via the door detector that all doors are closed.

7. The safety assistance system as claimed in claim 1, wherein a front region of the seat is equipped with an air bag for protecting a passenger on an opposite seat when a front seat and a back seat face toward each other oppositely.

8. A method of adjusting a setting of air bag activation, comprising steps of:
providing a microcontroller;
providing a set of seat detectors electrically connected to the microcontroller, said seat detectors including at least a seat rotation detector to detect whether a front seat is rotated backward to face a rear seat so as not to activate an air bag stored behind a front control panel in front of the front seat even if a passenger is sitting one said front seat.

9. The method as claimed in claim 8, wherein the set of seat detectors further includes a seat back tilting angle detector so as to decide how much air amount for deployment with regard to the corresponding seat.

10. The method as claimed in claim 8, wherein said set of seat detectors further includes a seat rid detector of a pressure format so as to recognize whether a corresponding seat is vacant or not for not activating the corresponding air bags.

11. The method as claimed in claim 8, further including a step of providing a door detector electrically connected to the microcontroller so as to activate the set of seat detectors after detecting all doors are closed.

12. The method as claimed in claim 8, further including a step of providing additional air bags in front region of the corresponding seats for protecting a passenger on an opposing seat.

13. The method as claimed in claim 8, further including a step of providing a air bag controller electrically connected to both the microcontroller and the corresponding air bags, wherein a setting of the air bag controller is adjusted according to data collected by the set of seat detectors.

14. A safety assistance system comprising:
a microcontroller;
a set of seat detectors electrically connected to the microcontroller and including at least a seat rotation detector for detecting whether a corresponding front seat is rotated to face backwardly;
an air bag controller electrically connected to the microcontroller with a setting adjustable according to collected data of the set of seat detectors; wherein
an air bag for said corresponding front seat is not activated when the corresponding front seat faces backward, even if said corresponding front seat carries a passenger thereon.

15. The safety assistance system as claimed in claim 14, wherein said set of seat detectors further includes a sear back tilting angle detector for deciding how much deployment air amount is required/

16. The safety assistance system as claimed in claim 14, further including a door detector electrically connected to the microcontroller, wherein the set of seat detectors is activated after that all doors are closed is detected by the door detector.

17. The safety assistance system as claimed in claim 14, wherein an addition air bag is stored in a front region of the corresponding seat for protecting the corresponding passenger on an opposing seat.

18. The safety assistance system as claimed in claim 14, where the set of seat detectors further includes a seat ride detector for detecting whether a passenger is on the corresponding seat so as to decide whether the corresponding air bag is requisitely activated.
